(19) United States
(12) Patent Application Publication
(10) Pub. No.: US 2023/0229886 A1
(43) Pub. Date: Jul. 20, 2023

(54) Modeling of Long-Range Interactions with Reduced Feature Materialization via Lambda Functions

(71) Applicant: Google LLC, Mountain View, CA (US)

(72) Inventor: Irwan Bello, San Francisco, CA (US)

(21) Appl. No.: 18/011,636

(22) PCT Filed: Jul. 7, 2021
(86) PCT No.: PCT/US2021/040664

§ 371 Date: Dec. 20, 2022

Related U.S. Application Data
(60) Provisional application No. 63/051,969, filed on Jul. 15, 2020.

(51) Int. Cl. G06N 3/04; G06N 3/08

(52) U.S. Cl. CPC G06N 3/04; G06N 3/08

(57) ABSTRACT

The present disclosure provides systems, methods, and computer program products for performing modeling of long-range interactions with reduced feature materialization, for example, in machine learning models. A computer-implemented method may include receiving a layer input comprising input data and context data, generating one or more lambda functions based, at least in part, on a content function and a position function for each of a plurality of context elements in the context data, and applying one or more of the generated lambda functions to the input data in association with generating a layer output associated with a respective lambda layer. Experimental results for image classification on ResNet and for object detection with RetinaNet show that examples of the present disclosure significantly outperform convolutional and attentional counterparts while providing increased accuracy and efficiency.

### RELATED APPLICATIONS

This application claims priority to and the benefit of U.S. Provisional Patent Application No. 63/051,969, filed Jul. 15, 2020, which is hereby incorporated by reference in its entirety.

### FIELD

The present disclosure relates generally to machine learning architectures. More particularly, the present disclosure relates to systems, methods, and computer program products to perform modeling of long-range interactions with reduced feature materialization in machine learning models using lambda functions.

### BACKGROUND

The modeling of long-range interactions is important in machine learning. Attention has emerged as a common approach for capturing long-range interactions and has become preferred over recurrence-based approaches. However, attention operations suffer from per-example quadratic memory complexity. In fact, a significant challenge in applying attention to large inputs comes from the large memory footprint and computational requirements associated with materializing attention maps such as per-example attention maps. Such resource burdens have hindered the use of attention, for example, in long sequences and multidimensional inputs such as images.

### SUMMARY

Aspects and advantages of examples of the present disclosure will be set forth in part in the following description, or can be learned from the description, or can be learned through practice of the examples.

One example aspect of the present disclosure is directed to a computer-implemented method to perform modeling of long-range interactions with reduced feature materialization in machine learning systems and models. For example, the computer-implemented method may be performed by a computing device associated with one or more machine learning models. In an example, a computing device receives one or more layer-inputs comprising input data and context data. Context data generally refers to one or more context elements each having an associated position with content, such as image data, textual data, audio data, video data, or any other type of data. The computing device generates a lambda function for each of one or more elements associated with input data. For example, lambda functions may be computed based on context data using content and position information. In addition, the computing device applies each of the generated lambda functions to a respective corresponding input element.

In various example implementations, a lambda function is a transformation which is generated based on available context, and which is applied directly to a respective input element without materializing per-example attention maps. Avoiding the per-example quadratic memory complexity of per-example attention maps permits implementation in more limited memory spaces compared to other schemes which make use of attention, while still taking into account context and in particular, long range interactions.

In an example, keys and values may be determined based on linearly projecting the context data where the keys are normalized across context positions based on a softmax function. A lambda layer provides functional message passing where each context element is associated with a content function that encodes how to transform query content based on the content, and a position function that encodes how to transform the query content based on the content and associated positions (i.e., query position and context position). In addition, the functional messages are averaged over all of the elements in the context, yielding the desired lambda function.

In an example, a computing device applies one or more of the generated lambda functions to the input data as part of generating a layer output for a lambda layer. For example, the input data may be used to generate one or more queries. One or more lambda functions then may be applied to the queries, such that each query interacts with every content position based on the content and query position/context position coordinates to capture long-range content and position-based interactions between queries and a context without attention maps.

Example implementations described herein are particularly but not exclusively applicable to image processing. In some cases, the machine-learned model is configured to perform an image processing task, i.e., receive an input image and to process the input image, i.e., process the intensity values for the pixels of the input image, to generate a model output for the input image. For example, the task may be image classification and the model output for a given image may be scores for each of a set of object categories, with each score representing an estimated likelihood that the image contains an image of an object belonging to the category.

Other aspects of the present disclosure are directed to various systems, apparatuses, non-transitory computer-readable media, user interfaces, cloud services, and electronic devices.

These and other features, aspects, and advantages of various examples of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a flow diagram of an example method to perform modeling of long-range interactions with reduced feature materialization according to examples of the present disclosure.

FIG. 2A depicts a block diagram of an example computing system that performs modeling of long-range interactions with reduced feature materialization according to examples of the present disclosure.

FIG. 2B depicts a block diagram of an example computing device that performs modeling of long-range interactions with reduced feature materialization according to examples of the present disclosure.

FIG. 2C depicts a block diagram of an example computing device that performs modeling of long-range interactions with reduced feature materialization according to examples of the present disclosure.

### DETAILED DESCRIPTION

### Overview

Generally, the present disclosure is directed to systems, methods, and computer program products to perform modeling of long-range interactions with reduced feature materialization with machine learning models. Examples described in the present disclosure enable dense long-range content and position-based interactions without materializing per-example attention maps and without the associated per-example quadratic memory complexity. As such, examples of the present disclosure provide improved performance and reduced computational requirements as compared to approaches based on attention operations.

While attention has become a preferred way of capturing long-range interactions, attention operations suffer from per-example quadratic memory complexity due to attention maps. For example, applying a single multi-head attention layer on a batch of 256 sequences of length 2048 with 8 heads requires 8 GB of memory, which is prohibitive in practice. Further, the large memory requirements of self-attention have hindered the use of attention operations in long sequences and multidimensional inputs such as images, which generally include tens of thousands of pixels.

To resolve these issues, the present disclosure provides examples of lambda function generation as an alternative to attention operations. In examples of the present disclosure, lambda function generation enables dense, long-range content and position-based interactions without materializing per-example attention maps. For example, lambda function generation transforms available contexts into individual lambda functions that are directly applied to each query without attention maps, resulting in significantly improved performance and reduced computational requirements.

Lambda networks, a new class of neural networks described in examples of the present disclosure, enable modeling of long-range dependencies with computational efficiency and reduced memory requirements as compared to alternative operations. Thus, lambda functions, lambda layers, and lambda networks can be routinely applied to very large inputs, such as long sequences and high-resolution images.

U.S. Provisional Patent Application No. 63/051,969 contains a summary of example implementations of the present disclosure and example experimental results in which examples of the present disclosure outperform convolutional and attentional counterparts in accuracy and efficiency. For example, in experiments, examples of the present disclosure improve a variety of image classification and object detection models (e.g., ResNet, RetinaNet).

The systems, methods, and computer program products described herein provide a number of technical effects and benefits. As one example, lambda functions, lambda layers, and lambda networks as described in the present disclosure provide modeling of long-range dependencies more rapidly and using fewer computing resources (e.g., less processing power, less memory usage, less power consumption, etc.), as compared to, for example, attention operations.

As another example of technical effect and benefit, lambda layers employ lambda functions generated from available contexts, the lambda functions being directly applied to queries, thus capturing long-range dependencies at a significantly reduced memory cost compared to attention maps. Furthermore, lambda networks employing lambda layers provide significant performance improvements and computational efficiency over convolutional and attentional techniques. In addition, lambda networks provide increased accuracy via fewer computational layers.

With reference now to the Figures, examples of the present disclosure will be discussed in further detail.

### Example Methods for Performing Modeling of Long-Range Interactions with Reduced Feature Materialization

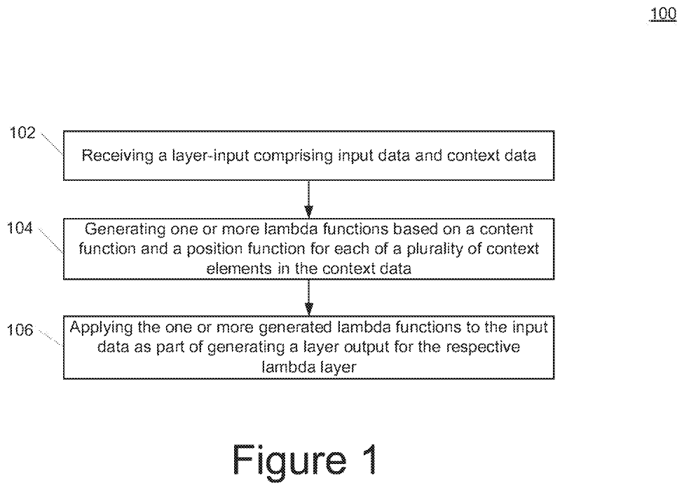

FIG. 1 depicts a flow diagram of an example method 100 to perform modeling of long-range interactions with reduced feature materialization according to the examples of the present disclosure. Although FIG. 1 depicts steps performed in a particular order for purposes of illustration and discussion, the methods of the present disclosure are not limited to the particularly illustrated order or arrangement.

The various steps of the method 100 can be omitted, rearranged, combined, and/or adapted in various ways without deviating from the scope of the present disclosure. Further, the operations and features described with respect to FIG. 1 also may be performed by one or more computing devices of a computing system and/or by one or more processing devices executing computer-readable instructions provided via a non-transitory computer-readable medium.

In some examples, a machine-learned model associated with one or more computing devices is configured to receive a model input, process, the model input, and generate a model output, for example, based on operations of example method 100 and features described throughout the present disclosure. As such, in some examples, the machine-learned model may, itself or through another associated machine-learned model, be operable to perform modeling of long-range interactions with reduced feature materialization as described herein.

Method 100 begins at block 102 when a computing system receives a layer-input comprising input data and context data. For example, the computing system may receive, collect, or obtain input data and context data together, separately, at one time, and/or at different times. Input data and context data then may be provided to one or more models or specific lambda layers thereof for performing modeling of long-range interactions with reduced feature materialization.

In an example, the input data can be represented as X∈ [symbol] ^{|n|×d}. As described also with reference to block 106, the computing system can derive one or more queries Q={(qₙ, n)} from the input data. For example, each query (qₙ, n) may be described by its content qₙ∈ [symbol] ^{|k|} and position n. As one example, the computing system can generate the queries from the input data by linearly projecting the input data via a query tensor (e.g., Q=XW_{Q}∈ [symbol] ^{|n|×|k|×|u|}, where W_{Q}∈ [symbol] ^{d×|k|×|u|}). In some examples, the input data may be transformed into one or more queries based on a series of one or more tasks to be performed with an associated purpose (e.g., image recognition, natural language processing, machine translation, etc.). In some examples, the computing system generates multiple queries from input data, applies similar processing to each of the queries, and combines the results of the processing to produce a result. For example, processing of a single query may be divided into multi-query batches to reduce complexities and associated computational cost.

In an example, context data can be represented as C∈ [symbol] ^{|m|×d} and can generally refer to a collection of one or more context elements where each context element (cₘ, m) is characterized by its content cₘ and position m in the context (e.g., pixel position in an image, word position in a sentence). In various examples, content generally may include image data, textual data, audio data, video data, and/or any other forms and types of data. For example, content generally may refer to content itself (e.g., an image or any other type of content) and/or text sequences or any other data generated from or otherwise representing any form of content. In some examples, the context data is equivalent to the input data. In other examples, the context data is separate and distinct from the input data.

At block 104, the computing system generates one or more lambda functions based on a content function and a position function for each of a plurality of context elements in the context data. In an example, a lambda layer of a machine-learned model receives a layer-input comprising input data and context data. For example, a lambda layer may accept the inputs X [symbol] ^{|n|×d}^{ᵢₙ} and the context C∈ [symbol] ^{|n|×d}^{_{c}} as layer-input. The lambda layer can generate one or more lambda functions that are then directly applied to queries, yielding outputs Y∈ [symbol] ^{|n|×d}^{ₒᵤₜ}.

In general, a lambda layer refers to a layer of a model that transforms contexts into lambda functions that are applied to input data or data derived therefrom, such as queries generated from input data. Lambda functions may in some examples be linear functions that are applied to input data. Lambda networks generally refer to neural networks comprising one or more lambda layers that dynamically generate their own computations based on their inputs. Lambda function generation may comprise generating lambda functions from a global or local scope (e.g., global lambda functions, local lambda functions). A content lambda function generally refers to a lambda function that models content-based interactions. A position lambda generally refers to a lambda function that models position-based interactions.

As one example process for generating a lambda function at block 104, the lambda layer can first transform the context data into keys K and values V using, respectively, a key tensor W_{K} and a value tensor W_{V}. As one example, K=CW_{K}∈ [symbol] ^{|m|×|k|×|u|}, where W_{K}∈ [symbol] ^{|m|×|v|×|u|} and V=CW_{V}∈ [symbol] ^{|m|×|v|×|u|}, where W_{V}∈ [symbol] ^{d×|v|×|u|}. Thus, in the example, the lambda layer determines keys and values by linearly projecting the context data.

In some implementations, the keys are normalized across context positions based on a softmax function. In some implementations, the lambda layer utilizes functional message passing where each context element is associated with a content function μₘ^{c}=K̅ₘVₘ^{T}∈ [symbol] ^{|k|×|u|} and a position function μₙₘ^{p}=EₙₘVₘ^{T}∈ [symbol] ^{|k|×|u|}. For example, the content function provides transformation of query content qₙ based on the content cₘ, while the position function provides transformation of the query content qₙ based on the content cₘ and positions (n,m) (i.e., query position n, content position m). In some implementations, translation-equivariant position interactions may be obtained, for example, based on ensuring that position embeddings satisfy Eₙₘ=Eₜ₍ₙ₎ₜ₍ₘ₎ for any translation t. Relative position embeddings may be defined as R∈ [symbol] ^{|k|×|r|×|u|} where r indexes possible relative positions for all (n,m) pairs, and performs re-indexing into E∈ [symbol] ^{|k|×|n|×|m|×|u|} such that Eₙₘ=R_{r(n,m}).

In an example, the functional messages are averaged over elements in the context, generating the desired lambda function λₙ as

$${λ}_{n} = {λ}^{c} + {λ}_{n}^{p} = \frac{1}{\vert m \vert} {Σ}_{m} ( {μ}_{m}^{c} + {μ}_{n m}^{p} ) = \frac{1}{\vert m \vert} {Σ}_{m} ( {\overline{K}}_{m} + {E}_{n m} ) {V}_{m}^{T} ∈ {ℝ}^{\vert k \vert \times \vert v \vert} ,$$

where λ^{c} represents a content lambda and λₙ^{p} represents a position lambda.

In the example above, hyperparameters of the example lambda layer may include key/query depth |k|, value depth |v|, and intra-depth |u|. The intra-depth |u| can be adjusted to provide additional dimensionality and parameterization to enable learning of more complex relationships. In an example, parameters of a lambda layer may include a tensor that linearly projects the inputs W_{Q}∈ [symbol] ^{d×|k|}, a tensor that linearly projects the context W_{K}∈ [symbol] ^{d×|k|×|u|}, a second tensor that linearly projects the context W_{V}∈ [symbol] ^{d×|v|×|u|}, and the positional embedding for the relation (n,m): Eₙₘ∈ [symbol] ^{|k|×|u|}. These parameters can be learned via various different machine learning techniques, including, for example, gradient-descent techniques on an objective function.

At block 106, the computing system applies one or more of the generated lambda functions to the input data as part of generating a layer output for the respective lambda layer. In an example, the computing system transforms input data into one or more queries (e.g., qₙ=W_{Q}xₙ). For example, input data may be transformed into one or more queries. Further, each of one or more generated lambda functions may be applied to each of the one or more queries. The one or more queries may be generated from the input data generally at any time.

In an example, the computing system applies one or more generated lambda functions to each of the respective queries as part of generating a layer output for a respective lambda layer. For example, lambda function output associated with a layer output of a lambda function may be generated based on yₙ=(λ^{c}+λₙ^{p})qₙ=λₙqₙ∈ [symbol] ^{|v|}. In applying a lambda function to a query, the query qₙ interacts with each of a plurality of context positions m based on the content cₘ and positions (n,m) (i.e., query position n, content position m), thus capturing dense content and position-based, long-range interactions without materializing attention maps.

One example complexity analysis for the above-described example is as follows. For a batch of |b| elements, each containing |n| inputs, the number of arithmetic operations and memory footprint required to apply our lambda layer are respectively Θ(bnmkv) and Θ(bnkv+knm). While a quadratic memory footprint still exists with respect to the input length due to the Eₙₘ parameters that capture position-based interactions, this quadratic term does not scale with the batch size as is the case with the attention operation which produces per-example attention maps. In some examples, the hyperparameter |k| can be set to a small value (such as |k|=8) and large batches of large inputs can be processed in cases where attention cannot.

In an example, a lambda layer performs multi-query operations as part of generating a layer output, for example, to mitigate large computational costs associated with large output dimensions. In an example, multi-query operations may be used to generate output by dividing a query into a plurality of queries. For example, the same lambda function then may be applied to each of the plurality of queries, and the resulting output from applying the lambda function to each of the queries can be concatenated or otherwise combined to generate a layer output.

In particular, recall that example lambda layers discussed above with reference to FIG. 1 map inputs xₙ∈ [symbol] ^{d} to outputs yₙ∈ [symbol] ^{d}. This implies that |v|=d. Small values of |v| may therefore act as a bottleneck on the feature vector yₙ but larger output dimensions |v| can incur an excessively large computational cost given Θ(bnmkv) and Θ(bnkv+knm) time and space complexities.

Example implementations of the present disclosure decouple the time and space complexities of example lambda layers from the output dimension d. In particular, in some implementations, rather than imposing |v|=d, |h| queries {qₙ^{h}} can be generated. The same lambda function λₙ can be applied to each query qₙ^{h}, and the outputs can be concatenated as eₙ=concat(λₙqₙ¹, . . . , λₙqₙ^{|h|}).

This operation can be referred to as a multiquery lambda layer as each lambda is applied to |h| queries. While this resembles the multihead or multiquery attention formulation, the motivation is different: in the present case, using multiquery lambdas reduces complexity and representational power. This can also be interpreted as forcing the lambda matrix to be block-wise with |h| equal repeated blocks. We now have d=|hv| and the time and space complexities become Θ(bnmkd/h) and Θ(bnkd/h+knm).

In an example, one or more lambda layers may be configured to operate with structured contexts, such as relative contexts which enable translation equivariance which provides a strong inductive bias in many learning scenarios. For example, translation-equivariant positions may be determined based on ensuring that position embeddings satisfy Eₙₘ=Eₜ₍ₙ₎ₜ₍ₘ₎ for any translation t. In addition, relative position embeddings may be defined as R∈ [symbol] ^{|k|×|r|×|u|} where r indexes possible relative positions for all (n,m) pairs, and performs re-indexing based upon E∈ [symbol] ^{|k|×|n|×|n|×|u|} such that Eₙₘ=R_{r(n,m)}.

In an example, one or more lambda layers may be configured to generate positional lambda functions for local contexts based on a regular convolution that treats a values n dimension in V as an extra spatial dimension. As such, computations may be restricted to a local scope where a lambda convolution obtains linear time and memory based on complexity with respect to input length. These implementations are readily usable with additional functionalities such as dilation and striding and enjoy highly optimized implementations on specialized hardware accelerators. This is in stark contrast to implementations of local self-attention which require materializing feature patches of overlapping query and memory blocks, increasing memory consumption and latency

In an example, one or more lambda layers may be configured to operate in association with masked contexts. For example, interactions between queries and masked context positions may be restricted or blocked when generating lambda functions based on applying a mask before summing contributions of context positions. In addition, keys can be normalized based on considering elements in view of their contexts.

TABLE 1
Hyperparameter, parameters and quantities of
interest describing one example lambda layer.

| Name | Type | Description |
|---|---|---|
| \|k\|, \|v\|, \|u\| | hyper- | key/query depth, value |
| | parameter | depth, intra-depth |
| W_{Q} ∈ [symbol] ^{d×\|k\|} | parameter | a tensor that linearly |
| | | projects the inputs |
| W_{K} ∈ [symbol] ^{d×\|k\|×\|u\|} | parameter | a tensor that linearly |
| | | projects the context |
| W_{V} ∈ [symbol] ^{d×\|v\|×\|u\|} | parameter | a tensor that linearly |
| | | projects the context |
| Eₙₘ ∈ [symbol] ^{d×\|k\|×\|u\|} | parameter | a positional embedding |
| | | for the relation (n, m). |
| X ∈ [symbol] ^{\|n\|×d} | input | the inputs |
| C ∈ [symbol] ^{\|m\|×d} | input | the context |
| Q = XW_{Q} ∈ [symbol] ^{\|m\|×\|k\|×\|u\|} | activation | the queries |
| K = CW_{K} ∈ [symbol] ^{\|m\|×\|k\|×\|u\|} | activation | the keys |
| V = CW_{V} ∈ [symbol] ^{\|m\|×\|v\|×\|u\|} | activation | the values |
| K̅ = softmaxₘ(K) | activation | the normalized keys |
| μₘ^{c} = Kₘ Vₘ^{T} ∈ [symbol] ^{\|k\|×\|v\|} | activation | content contribution |
| | | from context element m |
| μₙₘ^{P} = Eₙₘ Vₘ^{T} ∈ [symbol] ^{\|k\|×\|v\|} | activation | position contribution |
| | | from context element m |
| Y ∈ [symbol] ^{\|n\|×d} | outputs | the outputs |

### Example Devices and Systems

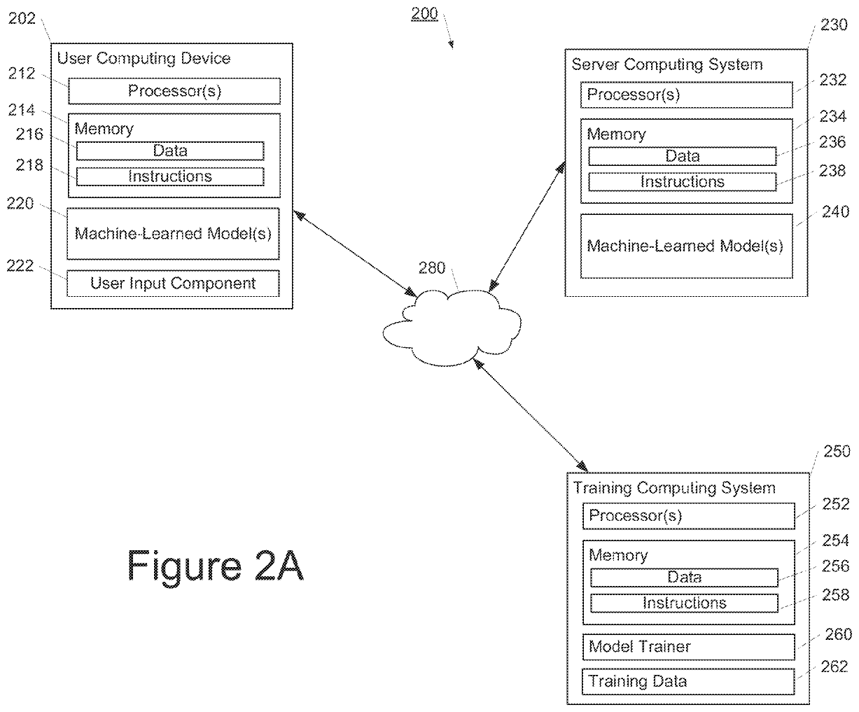

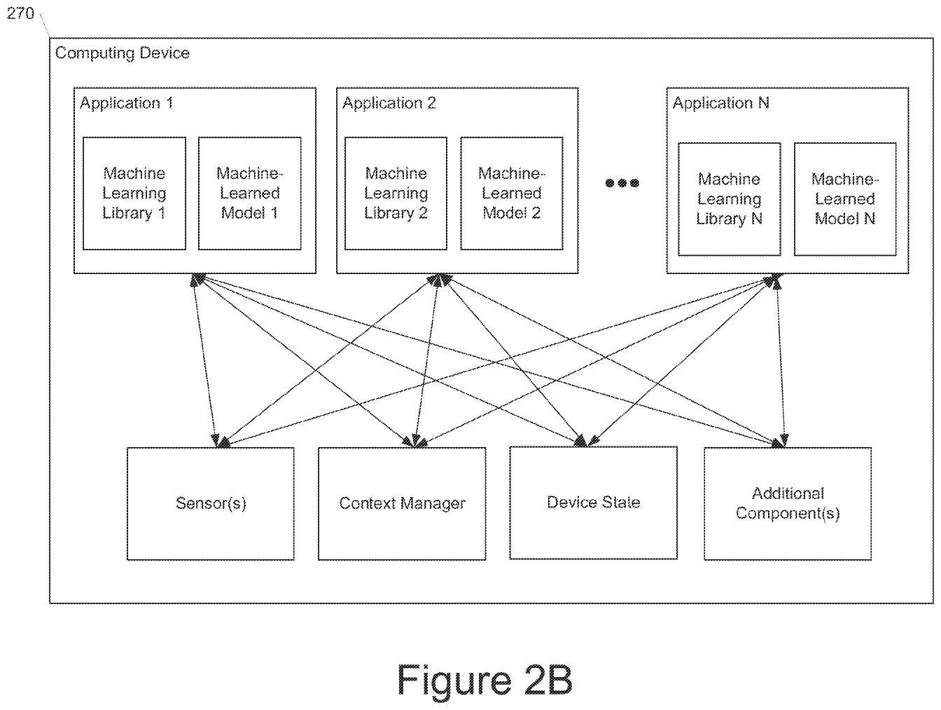

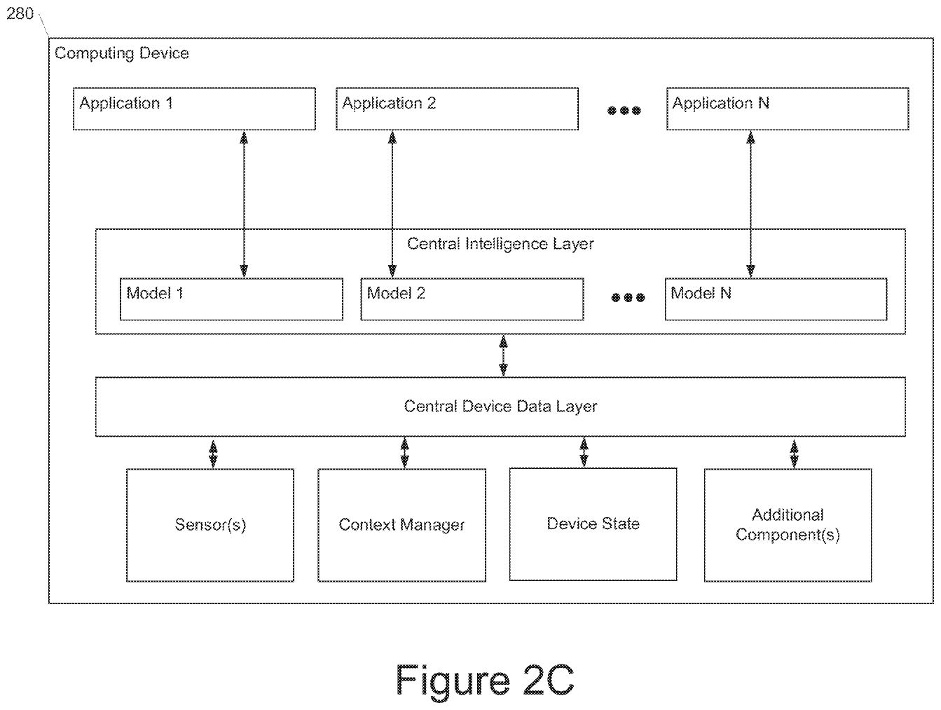

FIG. 2A depicts a block diagram of an example computing system 200 that performs modeling of long-range interactions with reduced feature materialization according to examples of the present disclosure. The system 200 includes a user computing device 202, a server computing system 230, and a training computing system 250 that are communicatively coupled over a network 280.

The user computing device 202 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 202 includes one or more processors 212 and a memory 214. The one or more processors 212 can be any suitable processing device (e.g., a processor core, a microprocessor, an ASIC, a FPGA, a controller, a microcontroller, etc.) and can be one processor or a plurality of processors that are operatively connected. The memory 214 can include one or more non-transitory computer-readable storage mediums, such as RAM, ROM, EEPROM, EPROM, flash memory devices, magnetic disks, etc., and combinations thereof. The memory 214 can store data 216 and instructions 218 which are executed by the processor 212 to cause the user computing device 202 to perform operations.

In some examples, the user computing device 202 can store or include one or more machine-learned models 220. For example, the machine-learned models 220 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some examples, the one or more machine-learned models 220 can be received from the server computing system 230 over network 280, stored in the user computing device memory 214, and then used or otherwise implemented by the one or more processors 212. In some examples, the user computing device 202 can implement multiple parallel instances of a single machine-learned model 220.

Additionally or alternatively, one or more machine-learned models 240 can be included in or otherwise stored and implemented by the server computing system 230 that communicates with the user computing device 202 according to a client-server relationship. For example, the machine-learned models 240 can be implemented by the server computing system 240 as a portion of a web service (e.g., a cloud-based, machine-learning platform service). Thus, one or more models 220 can be stored and implemented at the user computing device 202 and/or one or more models 240 can be stored and implemented at the server computing system 230.

The user computing device 202 can also include one or more user input component 222 that receives user input. For example, the user input component 222 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 230 includes one or more processors 232 and a memory 234. The one or more processors 232 can be any suitable processing device (e.g., a processor core, a microprocessor, an ASIC, a FPGA, a controller, a microcontroller, etc.) and can be one processor or a plurality of processors that are operatively connected. The memory 234 can include one or more non-transitory computer-readable storage mediums, such as RAM, ROM, EEPROM, EPROM, flash memory devices, magnetic disks, etc., and combinations thereof. The memory 234 can store data 236 and instructions 238 which are executed by the processor 232 to cause the server computing system 230 to perform operations.

In some examples, the server computing system 230 includes or is otherwise implemented by one or more server computing devices. In examples where the server computing system 230 includes a plurality of server computing devices, such server computing devices can operate according to sequential computing architectures, parallel computing architectures, or some combination thereof.

As described above, the server computing system 230 can store or otherwise include one or more machine-learned models 240. For example, the models 240 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 202 and/or the server computing system 230 can train the machine-learned models 220 and/or 240 via interaction with the training computing system 250 that is communicatively coupled over the network 280. The training computing system 250 can be separate from the server computing system 230 or can be a portion of the server computing system 230.

The training computing system 250 includes one or more processors 252 and a memory 254. The one or more processors 252 can be any suitable processing device (e.g., a processor core, a microprocessor, an ASIC, a FPGA, a controller, a microcontroller, etc.) and can be one processor or a plurality of processors that are operatively connected. The memory 254 can include one or more non-transitory computer-readable storage mediums, such as RAM, ROM, EEPROM, EPROM, flash memory devices, magnetic disks, etc., and combinations thereof. The memory 254 can store data 256 and instructions 258 which are executed by the processor 252 to cause the training computing system 250 to perform operations. In some examples, the training computing system 250 includes or is otherwise implemented by one or more server computing devices.

The training computing system 250 can include a model trainer 260 that trains the machine-learned models 220 and/or 240 stored at the user computing device 202 and/or the server computing system 230 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some examples, performing backwards propagation of errors can include performing truncated backpropagation through time. The model trainer 260 can perform a number of generalization techniques (e.g., weight decays, dropouts, etc.) to improve the generalization capability of the models being trained. In addition, the model trainer 260 can train models based on a set of training data 262. The training data 262 can include, for example, image data, textual data, audio data, video data, and/or other forms and types of data.

In some examples, if the user has provided consent, the training examples can be provided by the user computing device 202. Thus, in such examples, the model 220 provided to the user computing device 202 can be trained by the training computing system 250 on user-specific data received from the user computing device 202. In some examples, this process can be referred to as personalizing the model.

The model trainer 260 includes computer logic utilized to provide desired functionality. The model trainer 260 can be implemented in hardware, firmware, and/or software controlling a processor. For example, in some instances, the model trainer 260 includes program files stored on a storage device, loaded into a memory and executed by one or more processors. In other examples, the model trainer 260 includes one or more sets of computer-executable instructions that are stored in a tangible computer-readable storage medium such as RAM hard disk or optical or magnetic media.

The network 280 can be any type of communications network, such as a local area network (e.g., intranet), wide area network (e.g., Internet), or some combination thereof and can include any number of wired or wireless links. In general, communication over the network 280 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 2A illustrates one example computing system that can be used to implement various examples provided in the present disclosure. Other computing systems can be used as well. For example, in some instances, the user computing device 202 can include the model trainer 260 and the training dataset 262. In such examples, machine-learned models 220 can be both trained and used locally at the user computing device 202. In some of such examples, the user computing device 202 can implement the model trainer 260 to personalize machine-learned models 220 based on user-specific data.

In some examples, the input to the machine-learned model(s) of the present disclosure (e.g., machine-learned model 220, machine-learned model 240) can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some examples, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some examples, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some examples, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some examples, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some examples, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

FIG. 2B depicts a block diagram of an example computing device 270 that performs modeling of long-range interactions with reduced feature materialization according to examples of the present disclosure. The computing device 270 can be a user computing device (e.g., user computing device 202) or a server computing device (e.g., server computing system 230).

The computing device 270 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some examples, each application can communicate with each device component using an application programming interface (API) (e.g., a public API, a private API, secure open APIs, web APIs, etc.). In some examples, the API used by each application is specific to that application.

FIG. 2C depicts a block diagram of an example computing device 280 that performs modeling of long-range interactions with reduced feature materialization according to examples of the present disclosure. The computing device 280 can be a user computing device (e.g., user computing device 202) or a server computing device (e.g., server computing system 230).

The computing device 280 includes a number of applications (e.g., applications 1 through N). Each application is in communication with a central intelligence layer. Example applications include a text messaging application, an email application, a dictation application, a virtual keyboard application, a browser application, etc. In some examples, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model (e.g., a model) can be provided for each application and managed by the central intelligence layer. In other examples, two or more applications can share a single machine-learned model. For example, in some examples, the central intelligence layer can provide a single model (e.g., a single model) for all of the applications. In some examples, the central intelligence layer is included within or otherwise implemented by an operating system of the computing device 280.

The central intelligence layer can communicate with a central device data layer. The central device data layer can be a centralized repository of data for the computing device 280. As illustrated in FIG. 2C, the central device data layer can communicate with a number of other components of the computing device, such as, for example, one or more sensors, a context manager, a device state component, and/or additional components. In some examples, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for modeling long-range interactions with reduced feature materialization, comprising:
one or more processors; and
one or more non-transitory computer-readable media that collectively store:
a machine-learned model configured to receive a model input and process the model input to generate a model output, wherein the machine-learned model comprises one or more lambda layers, wherein each of the one or more lambda layers is configured to perform operations comprising:
receiving a layer-input comprising input data and context data comprising a plurality of context elements;
generating one or more lambda functions based, at least in part, on a content function and a position function of each of the plurality of context elements in the context data; and
applying the one or more generated lambda functions to the input data as part of generating a layer output associated with the respective lambda layer.

2. The computing system of claim 1, wherein generating the one or more lambda functions comprises:
averaging content functions and position functions for the plurality of the context elements.

3. The computing system of claim 1, wherein the operations further comprise:
determining keys and values based on linearly projecting the context data.

4. The computing system of claim 1, wherein each respective content function encodes a transform of query content based on the context data, independent of a target query position.

5. The computing system of claim 1, wherein each respective position function encodes a transform of query content based on the context data, a query position, and a position in the context data.

6. The computer system of claim 1, wherein translation-equivariant position interactions are determined based on relative positions of one or more pairs of a plurality of query positions and a plurality of positions in the context data.

7. The computing system of claim 1, wherein the operations further comprise:
transforming the input data into one or more queries, wherein applying the one or more generated lambda functions to the input data comprises applying at least one of the generated lambda functions to each of the one or more queries.

8. The computing system of claim 1, wherein applying the one or more generated lambda functions to the input data comprises combining a series of outputs resulting from applying at least one of the generated lambda functions to a plurality of queries associated with the input data.

9. The computer system of claim 1, wherein one or more of the lambda functions are global lambda functions.

10. The computer system of claim 1, wherein one or more of the lambda functions are local lambda functions.

11. The computer system of claim 1, wherein generating the one or more lambda functions comprises masking one or more positions of the context data.

12. The computer system of claim 1, wherein the machine-learned model is configured to perform an image processing task, wherein the image processing task comprises image classification, object detection, image recognition, image segmentation, image data modification, image encoding, image compression or image upscaling.

13. (canceled)

14. (canceled)

15. A computer-implemented method for performing modeling of long-range interactions with reduced feature materialization in machine learning models, the computer-implemented method comprising:
running, by a computing system comprising one or more computing devices, a machine-learned model to receive a model input and process the model input to generate a model output;
wherein the machine-learned model comprises one or more lambda layers; and
wherein running the machine-learned model comprises, for each of the one or more lambda layers:
receiving, by the computing system, a layer-input comprising input data and context data comprising a plurality of context elements;
generating, by the computing system, one or more lambda functions based, at least in part, on a content function and a position function of each of the plurality of context elements in the context data; and
applying, by the computing system, the one or more generated lambda functions to the input data as part of generating a layer output associated with the respective lambda layer.

16. The computer-implemented method of claim 15, wherein generating the one or more lambda functions comprises:
averaging content functions and position functions for the plurality of the context elements.

17. The computer-implemented method of claim 15, wherein the running the machine-learned model further comprises:
determining keys and values based on linearly projecting the context data.

18. The computer-implemented method of claim 15, wherein each respective content function encodes a transform of query content based on the context data, independent of a target query position.

19. The computer-implemented method of claim 15, wherein each respective position function encodes a transform of query content based on the context data, a query position, and a position in the context data.

20. One or more non-transitory computer-readable media that store:
a machine-learned model configured to receive a model input and process the model input to generate a model output, wherein the machine-learned model comprises one or more lambda layers, wherein each of the one or more lambda layers is configured to perform operations comprising:
receiving a layer-input comprising input data and context data comprising a plurality of context elements;
generating one or more lambda functions based, at least in part, on a content function and a position function of each of the plurality of context elements in the context data; and
applying the one or more generated lambda functions to the input data as part of generating a layer output associated with the respective lambda layer.

21. The one or more non-transitory computer-readable media of claim 20, wherein one or more of the lambda functions are global lambda functions.

22. The one or more non-transitory computer-readable media of claim 20, wherein one or more of the lambda functions are local lambda functions.
